(19) United States
(12) Patent Application Publication
(10) Pub. No.: US 2004/0212555 A1
(43) Pub. Date: Oct. 28, 2004

(54) Portable electronic device with integrated display and camera and method therefore

(76) Inventor: Mark A. Falco, Lake Worth, FL (US)

Correspondence Address: Randi L. Dulaney, Motorola, Inc., Law Department, 8000 West Sunrise Boulevard, Fort Lauderdale, FL, 33322, US

(21) Appl. No.: 10/421,615

(22) Filed: Apr. 23, 2003

(51) Int. Cl. G09G 3/18

(52) U.S. Cl. 345/50

(57) ABSTRACT

A portable electronic device (10) has an integrated display and camera. The portable electronic device (10) includes a printed circuit board (60), a display (30) having one or more display layers, and an integrated camera coupled between the one or more display layers and the printed circuit board (60), wherein the one or more display layers are constructed such that a light stream (105) flows through to the integrated camera.

### BACKGROUND OF THE INVENTION

1. Field of the Invention

This invention relates in general to portable electronic devices and more particularly to portable electronic devices having multifunctional capabilities.

2. Description of the Related Art

Cellular telephones, messaging devices, PDAs (Personal Digital Assistants) and other portable electronic devices having communication capability have become fixtures of everyday life over the last several years. As they evolve, prices continue to fall while the devices' capabilities have expanded. Currently, such devices can be used in many places to make wireless connection to the Internet, play games, as well as carry out email and other messaging functions. It can readily be anticipated that as time goes by, the capabilities of such devices will continue to expand as prices continue to fall, making use of such devices a permanent part of people's daily lives. Device manufacturers continue to utilize technological innovations carefully balance excitement and fun with convenience and simplicity of use. Device customers desire to continuously improve productivity and be one step ahead of the crowd with digital customization and applications. At the same time, they desire devices with creative entertainment and messaging features. To meet customers' demands, device manufacturers have created devices that include large displays.

Further, some device manufacturers are offering connectivity to cameras for intermixing of the various functions. For example, there are camera accessories that can be connected to a cellular telephone. Such accessories allow the device user to take pictures, view them on the display of cellular telephone, and send them to another cellular phone which supports the same standard. Some devices further provide capability to send photos taken from the cellular phone to a PC. One drawback of using a camera accessory is the requirement of two different devices to perform the desired functionality.

Lastly, some device manufacturers are offering portable electronic devices with built-in digital cameras. A major drawback of today's integrated cameras into portable electronic devices is the additional size, price, and memory required.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is an illustration of a portable electronic device.

FIG. 2 is an exploded view of the portable electronic device of FIG. 1.

FIGS. 3 through 7 illustrate further detail of the portable electronic device of FIGS. 1 and 2.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

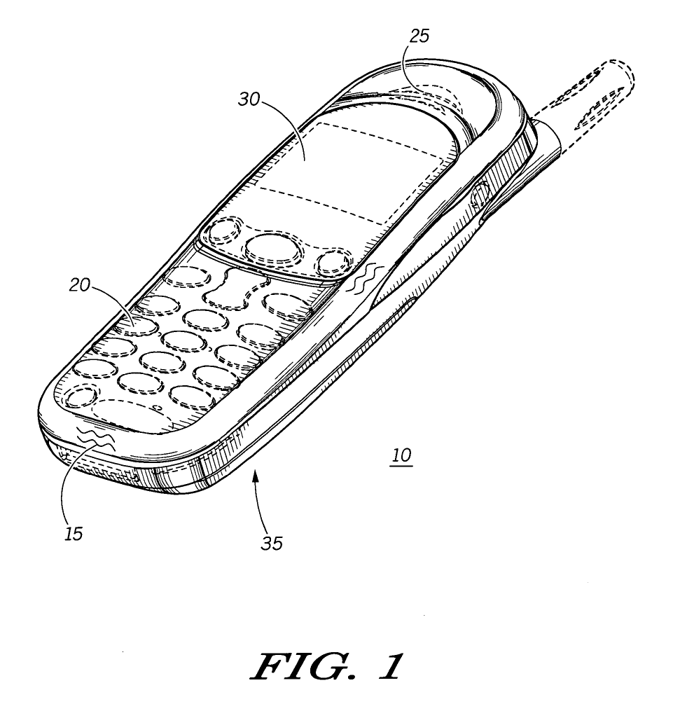

Referring to FIG. 1, a portable electronic device 10 is illustrated. The portable electronic device 10, for example, can be a cellular telephone (as illustrated), a cordless telephone, a wired landline telephone, or a personal communicator such as the V200 Personal Communicator manufactured by Motorola Inc. of Schaumburg, Ill. Similarly, the portable electronic device 10 can be a PDA, a portable personal computer, or an equivalent. In the following description, the term “portable electronic device” refers to any of the devices mentioned above or an equivalent.

The portable electronic device 10 preferably includes a user interface (such as a microphone 15, a keypad 20, and an earpiece 25, a display 30, and a housing 35. The microphone 15, for example, converts an acoustic input signal received from a voice transmission to the portable electronic device 10 into an electric input signal. The earpiece 25 can convert an electric output signal into an acoustic output signal transmitted from the portable electronic device 10 to be heard by the listener of the portable electronic device 10. The keypad 20 allows the user of the portable electronic device 10 to enter data such as phone numbers and text memos and to perform various functions within the portable electronic device 10. The display 30 displays data such as one or more communication messages, phone numbers, and caller identifications. The display 30 further can display graphics such as screen savers, wallpaper, gaming applications, and the like. The housing 35 encloses the various elements of the portable electronic device 10 and provides mechanical support for the device.

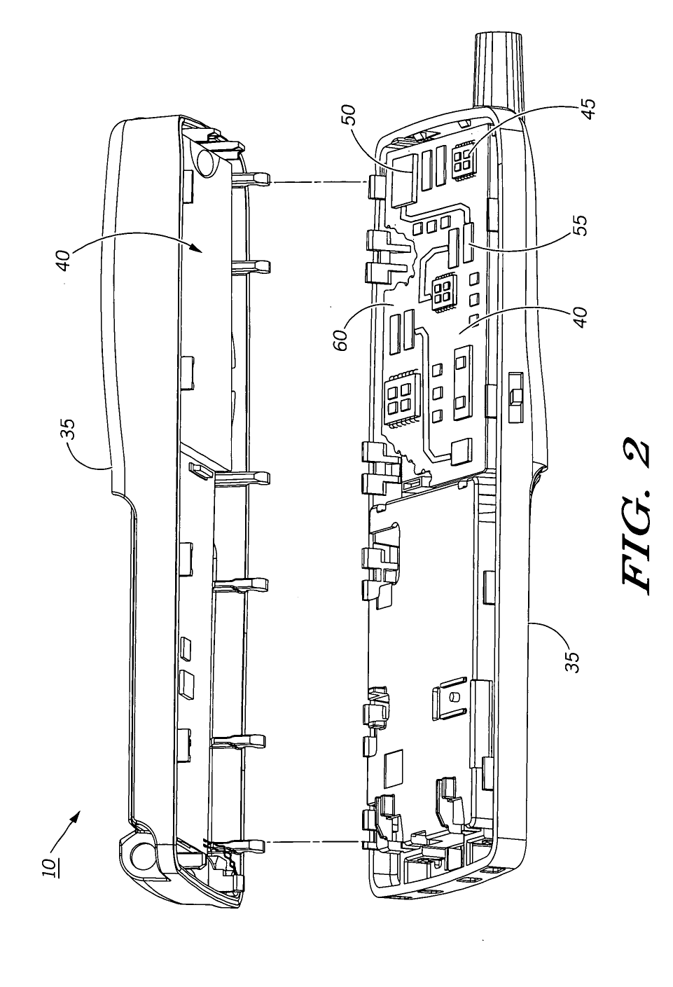

FIG. 2 is an exploded view of the portable electronic device 10 of FIG. 1. As illustrated in FIG. 2, the portable electronic device 10 includes a plurality of internal components 40 mounted upon a printed circuit board 60. The housing 35 encases the plurality of internal components 40, providing covering, protection and structural support. Preferably, and in accordance with the present invention, the plurality of internal components 40 includes a camera circuit 45. The camera circuit 45 includes necessary circuitry for providing camera functionality to the portable electronic device 10. Preferably, the portable electronic device 10 includes functionality of a digital camera. For example, the camera circuit 45 includes software and circuitry for the millions of calculations that are made in just a few seconds each time a picture is taken. It's these calculations that make it possible for the camera to preview, capture, compress, filter, store, transfer, and display the image. Typically, the camera circuit 45 is a microprocessor programmed to perform these calculations.

The plurality of internal components 40 further preferably includes a processor 50. The processor 50 can be programmed with software applications to control the operation of the various plurality of internal components 40 including the camera circuit 45. Alternatively, the processor 50 can include all the required functionality of the camera circuit 45 integrated within. In this alternative, the camera circuit 45 may be unnecessary.

To perform the necessary functions of the portable electronic device 10, the processor 50 is coupled to a memory 55, which preferably includes a random access memory (RAM), a read-only memory (ROM), an electrically erasable programmable read-only memory (EEPROM), and flash memory. The memory 55, for example, includes memory locations for the storage of one or more received or transmitted messages, one or more software applications, image data, and the like. The flash memory is especially useful for easy and fast information storage of the images taken by an integrated camera function.

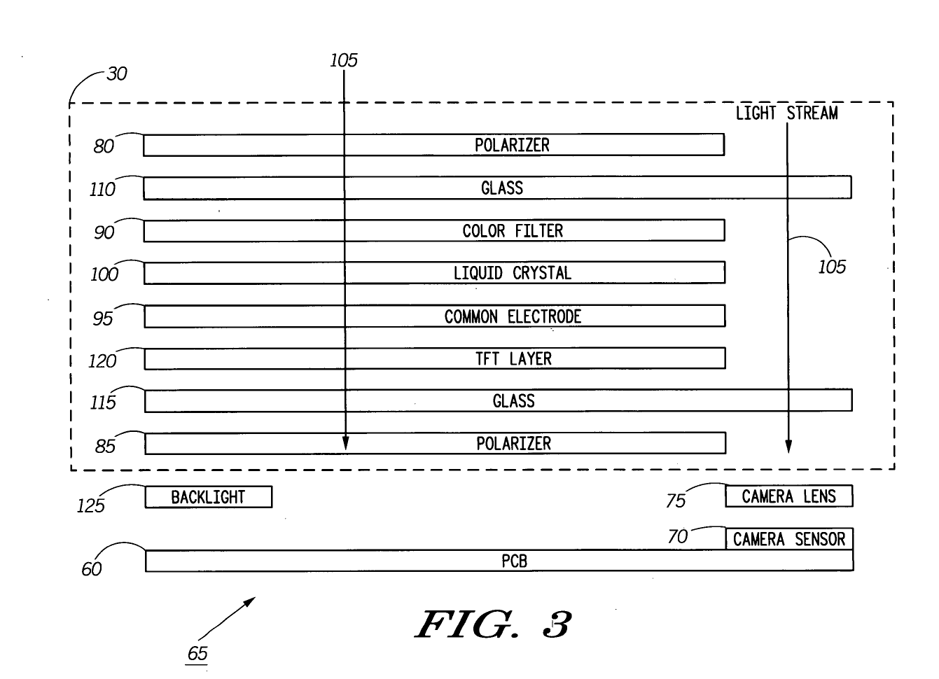

FIG. 3 illustrates further detail of the display 30 incorporating camera functionality in accordance with one embodiment of the present invention. It will be appreciated that the present invention allows for the novel construction of an integrated camera within a liquid crystal display (LCD) such as the display 30 or within any device incorporating a LCD. A camera, in accordance with the present invention, could be integrated into a main LCD display or external electrically connected display (not shown). As illustrated, the integrated display and camera 65 include a camera sensor 70 and an integral camera lens 75 mounted below the display 30 on the printed circuit board 60 or other substrate. Components (i.e. display layers) of the integrated display and camera 65 including one or more glass layers (110, 115), one or more polarizers (80, 85), a color filter 90, a common electrode 95 (for example, made of indium-tin oxide), and a layer of liquid crystal 100 are constructed (i.e.: cut away) to allow a light stream 105 to penetrate to the camera sensor 70. For LCD functionality, the light stream 105 passes through the liquid crystal layer 100 and through the color filter 90. The color filter 90 blocks all wavelengths of light except those within the range of that pixel. In a typical RGB display, the color filter 90 is integrated into the upper glass colored microscopically to render each individual pixel red, green or blue. The areas in between the colored pixel filter areas are printed black to increase contrast. After a beam of light passes through the color filter 90, it passes through the TFT layer (thin film technology layer) 120. The TFT layer 120 is composed of a thin film transistor matrix, with one transistor at each pixel. Next, the light stream 105 passes through another polarizer 85 to sharpen the image and eliminate glare. The image is then available for viewing.

To perform the camera functionality, the camera lens 75 focuses the light stream 105 to create an image. The camera lens 75 focuses the light stream 105 onto the camera sensor 70 which can be a semiconductor device that records light electronically. The camera circuit 45 (not shown) and/or the processor 50 then breaks this electronic information down into digital data. The camera sensor 70, for example, can be a charge coupled device (CCD), a complementary metal oxide semiconductor (CMOS) technology device, or an equivalent. The camera sensor 70 converts the light stream 105 into electrons at various photo sites. The next step is to read the value (accumulated charge) of each cell in the image. In a CCD device, the charge is actually transported across the chip and read at one corner of the array. An analog-to-digital converter turns each pixel's value into a digital value. In most CMOS devices, there are several transistors at each pixel that amplify and move the charge using more traditional wires. Those skilled in the art will recognize that the present invention can be implemented using conventional CCD and CMOS cameras with integrated fixed length camera lens and on board signal processing. Typically such devices are very low profile, facilitating utilization in accordance with the described invention. For example, such devices typically have an overall thickness of seven (7) to ten (10) millimeters (mm). Some CMOS devices also contain on board driver circuitry.

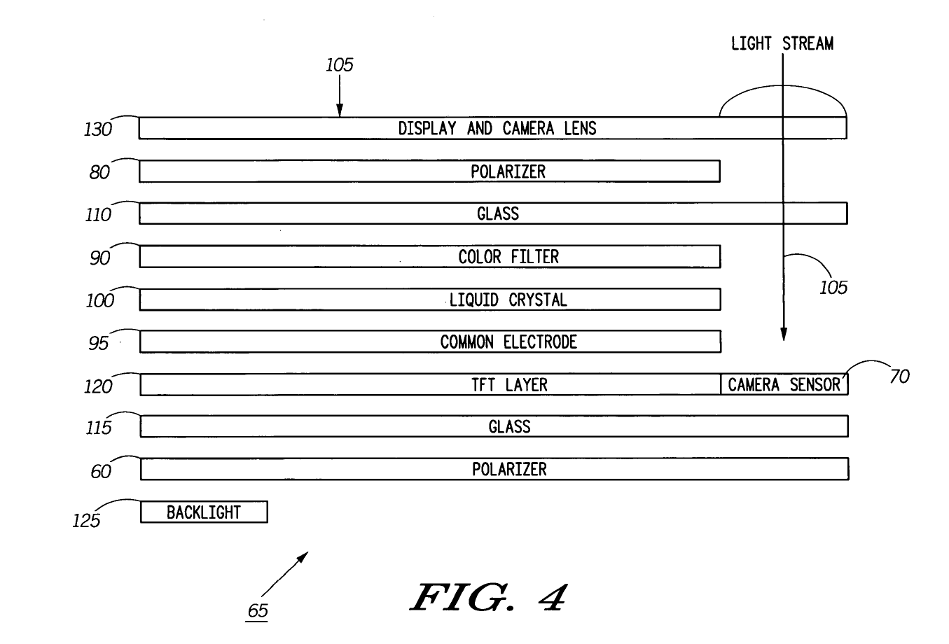

FIG. 4 illustrates further detail of the display 30 incorporating camera functionality in accordance with an alternate embodiment of the present invention. As illustrated in FIG. 4, the camera sensor 70 can be integrated into the TFT layer 120. The transistor matrix that forms the camera itself is fabricated in the same layer as the TFT display layer. The TFT layer 120 is composed of a thin film transistor matrix, with one transistor for each color. Each individual transistor controls an individual pixel or picture element. The liquid crystal at each pixel, in its normal state with no voltage applied, allows the light coming through the polarizing layer to pass through the assembly. When a voltage is applied, the liquid crystals twist in proportion to the voltage, changing their polarization and blocking the path of the light. By varying the voltage from the transistors to each pixel, the degree of twist can be controlled, effectively controlling the brightness of each pixel and each color. The electrical conductors are then routed to an Indium Tin Oxide (ITO) shelf where a flexible circuit is attached. This circuit can then carry electrical impulses to other parts of the circuit. The camera driver can use chip on board (COB), chip on flex (COF), or chip on glass (COG) technology. TFT active matrix display, can be, for example, composed of Amorphous Silicon. A TFT composed of Polycrystalline silicon will support CMOS circuitry.

Further, as illustrated in FIG. 4, the camera lens 75 can be integrated into a LCD lens cover or other structure. For example, as illustrated, the display and camera lens 130 can include both the LCD lens and the camera lens functionality. The camera lens could be a set of plano-convex, plano-concave, or concave-convex lenses integrated with the LCD lens or a single integrated lens. The lens causes light to converge at a fixed point onto the TFT layer which records light electronically and functions as the camera sensor 70. As the light moves from the air into the lens, the light slows down, bending toward normal (perpendicular). As the light exits the lens, it speeds up, bending the light away from normal. This property of bending light and the curvature of the lenses is what causes the light to converge or focus on a point. The top polarizer 80, the color filter 90, the liquid crystal layer 100, and the common electrode 95 are cut away to allow the light stream 105 to penetrate to the camera sensor 70.

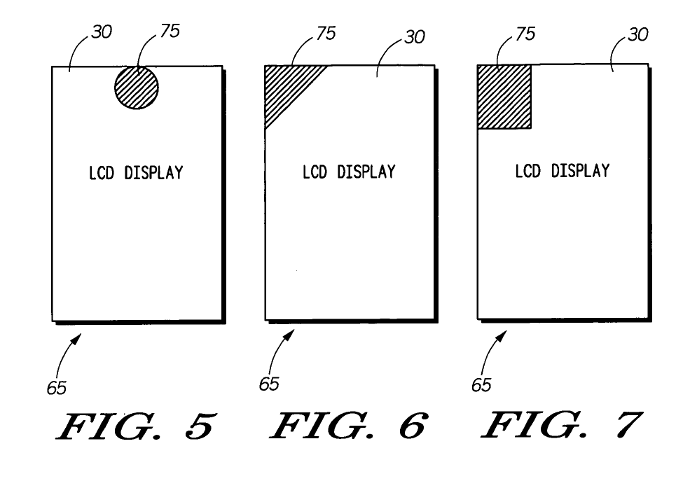

FIGS. 5 through 7 illustrate various embodiments for the integration of the camera and the display 30 to form the integrated display and camera 65. It will be appreciated by those of ordinary skill in the art that the camera sensor 70 (not shown) and the camera lens 75 can be integrated anywhere on the LCD display 30 such as any of the four corners in a variety of lens configurations (circle, oval, rectangle, triangle).

The integrated display and camera 65 as illustrated in FIGS. 3, 4, and 5 provide a compact method of using each layer of the existing LCD of a portable electronic device for multiple functions thus minimizing cost and size impact of adding a camera to the device. Both alternatives provide a means for the camera function to exist in a small portion of the LCD.

The portable electronic device, the integrated display and camera, and associated processes discussed above and the inventive principles thereof are intended to provide meaningful information with regards to providing devices with integrated display and camera functionality. It is expected that one of ordinary skill given the above described principles, concepts and examples will be able to implement other alternative procedures that are device dependent and that will also offer additional quick and efficient processes and systems for integrating display and camera functionality. It is anticipated that the claims below cover many such other examples.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A portable electronic device comprising:
an integrated display and camera comprising:
one or more display layers,
wherein the one or more display layers are constructed to simultaneously perform display and camera functionality.

2. A portable electronic device as recited in claim 1, wherein the integrated display and camera further comprises:
a camera lens, wherein the camera lens focuses a light stream to create an image, and
a camera sensor coupled to the camera lens, wherein the camera sensor records the focused light stream electronically.

3. A portable electronic device as recited in claim 1, wherein the one or more display layers are chosen from a group consisting of one or more glass layers, one or more polarizers, a color filter, a common electrode, and a layer of liquid crystal.

4. A portable electronic device as recited in claim 2 wherein the one or more display layers include:
a liquid crystal layer, and
a color filter, wherein the wherein the light stream further passes through the liquid crystal layer and through the color filter to provide liquid crystal display functionality.

5. A method for providing display and camera functionality within an integrated display and camera of a portable electronic device comprising:
creating an image for viewing on the integrated display and camera by:
passing a light stream through an integrated display and camera lens;
color filtering the light stream,
passing the light stream through a liquid crystal layer,
passing the color filtered light stream through a thin film technology layer composed of one transistor at each pixel of the color filtered light stream, and
passing the light stream through a polarizer to create the image; and
creating a photographic image using the integrated display and camera by:
focusing a photographic light stream using a the integrated display and camera lens,
creating a camera sensor using the thin film technology layer,
recording the photographic light stream electronically using a camera sensor, and
processing the electronic recording into digital data to form the photographic image.

6. A portable electronic device as recited in claim 1, wherein the integrated display and camera further comprises:
an integrated display and camera lens, wherein the integrated display and camera lens is adapted to:
focus a light stream to create an image, thereby providing camera functionality; and
focus the light stream for further display processing, thereby providing display functionality.

7. A portable electronic device as recited in claim 1, wherein the one or more display layers further comprise:
a thin film technology layer, wherein the thin film technology layer includes:
a transistor matrix that forms an integrated camera sensor for providing camera functionality, and
wherein each transistor of the transistor matrix is associated with a pixel of the display for providing display functionality.

8. A portable electronic device as recited in claim 6 wherein a camera lens portion of the integrated display and camera lens comprises one or more lenses chosen from a group consisting of a plano-convex, a plano-concave, or a concave-convex lens.

9. A portable electronic device as recited in claim 8 wherein the camera lens portion of the integrated display and camera lens cause light to converge at a fixed point on the thin film technology layer which records light electronically and functions as the camera sensor.

10. A portable electronic device as recited in claim 6, wherein the integrated display and camera further comprises:
a camera sensor coupled to the integrated display and camera lens, wherein the camera sensor records the focused light stream electronically, and
further wherein the one or more display layers are constructed to allow a light stream to penetrate to the camera sensor.

11. A portable electronic device as recited in claim 10 wherein the one or more display layers are chosen from a group consisting of a polarizer, a color filter, a liquid crystal layer, and a common electrode.
